(19) United States
(12) Patent Application Publication
(10) Pub. No.: US 2006/0068834 A1
(43) Pub. Date: Mar. 30, 2006

(54) Method and apparatus for detachable and configurable user interfaces for ultrasound systems

(76) Inventor: Paul H. Jones, Mercer Island, WA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/957,448

(22) Filed: Sep. 30, 2004

(51) Int. Cl. H04B 1/38

(52) U.S. Cl. 455/550.1; 455/557

(57) ABSTRACT

A method and apparatus for detachable and configurable user interfaces for ultrasound systems. The apparatus of one embodiment comprises a mating surface to physically receive a detachable user interface. The detachable user interface is comprised of a plurality of wireless control modules. A wireless communication device is coupled to a processor. The wireless communication device is to receive commands from the detachable user interface. The wireless communication device is to communicate the commands to processor for execution.

### FIELD OF THE INVENTION

The present disclosure pertains to the field of user interfaces. In particular, a user interface including detachable wireless control modules that can be configured into different arrangements.

### DESCRIPTION OF RELATED ART

A typical ultrasound system is controlled through a user interface that is located on the front of the system. This user interface can include a large number of buttons, switches, keys, etc. But in order to manipulate these controls, the operator generally has to be seated in front of the ultrasound system or be within fairly close proximity of the machine (i.e., within arm's length distance). However, there can be occasions where the ultrasound examination may require the sonographer to interact with a patient just out of reach of the controls or the sonographer is in an awkward position. Similarly, there can be other occasions where one person is operating the ultrasound system and another person such as a doctor wants to make an adjustment to the system from across the room.

Furthermore, the control panels of ultrasound systems are generally permanently affixed to the console and allow for only limited user reconfiguration, if any. For example, the user interface of some systems include a set number of keys, buttons, knobs, etc. with predefined functions. An operator may wish to configure the functionality of these controls for various reasons such as greater convenience. For example, there may be certain controls that are regularly used, but in awkward locations on the console. Or the operator may be dominant in one hand and finds it difficult to reach to the opposite side of the control panel to operate a pointing device.

Most ultrasound machines are designed to be used for different applications (e.g. general imaging, vascular, obstetrics, cardiac). These applications have different emphases on the various modes (B-mode, color, Doppler, power, 3-D, extended field of view, tissue harmonic imaging, contrast, etc.) and the types of measurements and reports required. Therefore the ultrasound system user interfaces (control panel, keyboard, on-screen menus) are not optimized for any one application but are generally compromises addressing several types of exams. Furthermore, different users often have different user interface preferences based in part on their training and the workflow at a particular ultrasound laboratory. Some users prefer an interface with many dedicated knobs on the control panel, while others prefer an interface with fewer knobs and on-screen menus or LCD display controls. Ultrasound system manufacturers have long been challenged to design a user interface and control panel to best meet all these needs and preferences. But by necessity, it has always been a compromise.

Thus, there is a need to provide for an improved user interface on diagnostic medical ultrasound imaging systems to overcome the problems described above.

### BRIEF SUMMARY

A method and apparatus for detachable and configurable user interfaces for ultrasound systems is disclosed. The apparatus of one embodiment comprises a mating surface to physically receive a detachable user interface. The detachable user interface is comprised of a plurality of wireless control modules. A wireless communication device is coupled to a processor. The wireless communication device is to receive commands from the detachable user interface. The wireless communication device is to communicate the commands to processor for execution.

Other features and advantages of the present invention will be apparent from the accompanying drawings and from the detailed description that follow below.

### BRIEF DESCRIPTION OF THE FIGURES

The present invention is illustrated by way of example and not limitation in the Figures of the accompanying drawings, in which like references indicate similar elements.

FIG. 1 is a block diagram of a medical diagnostic ultrasound imaging system including detachable and configurable user interfaces in accordance with one embodiment of the present invention;

FIGS. 2A-H are illustrations of various user interface configurations for detachable control panels as implemented on an ultrasound system in accordance with one embodiment of the present invention; and

FIG. 3 is a flowchart illustrating one embodiment of a method to configure detachable user control panels for use.

### DETAILED DESCRIPTION

The following description describes embodiments of a method and apparatus for detachable and configurable user interfaces for ultrasound systems. In the following description, numerous specific details such as ultrasound imaging system components, wireless interface protocols, and the like are set forth in order to provide a more thorough understanding of the present invention. It will be appreciated, however, by one skilled in the art that the invention may be practiced without such specific details. Additionally, some well known structures, algorithms, and the like have not been shown in detail to avoid unnecessarily obscuring the present invention.

A diagnostic medical ultrasound system with a user interface including detachable and configurable modules is provided. With embodiments, an ultrasound system can be made more flexible by offloading controls of the user interface onto detachable modules without the disadvantages concomitant with hardwired connection to the system. By using a detachable control modules having wireless capabilities, the location of the system operator is not limited to areas directly in front of or within arms length of the ultrasound system, thereby increasing usability. The wireless connection also avoids the inconvenience of interrupting an ultrasound examination to reach over to an attached control panel if the position is inconvenient. Similarly, wireless communication between the ultrasound imaging system and the detached control modules eliminates the need to untangle or arrange cables that may ordinarily be needed to connect the control modules to the system.

The basic system architecture of the ultrasound system implementing embodiments of the present invention allows different control panels to be attached to and detached from the body of the system. A detachable control panel can be moved from one ultrasound system to another. Thus, depending on the immediate need, a “vascular control panel” or “obstetrics control panel” can be attached to one system, and then removed and attached to another system. In one embodiment, these two ultrasound systems (platforms) can even be different—the same control panel could be moved from a high performance system to a midrange system or from a highly portable system to less portable system.

During an ultrasound exam, the sonographer must frequently make adjustments or annotations using the control panel or QWERTY keyboard on the ultrasound system. This is often awkward as the sonographer is also busy scanning the patient and may need to reach some distance to the control panel or keyboard. With embodiments of the present invention, all or part of the user interface (keyboard and/or control panel) can be removed from the ultrasound system and relocated to a more convenient location such as set on a table, bed, stand, or a specially designed rack. The modularity of the removable control panel allows one or more control modules to be detached from the ultrasound system for remote control.

Embodiments of the present invention provide a way for the same ultrasound system to be controlled by different detachable control panels that can may be configured in a variety of ways to meet the users needs or preferences. For example, one type of control panel can contain a large number of dedicated knobs to access and control various ultrasound modes, whereas another control panel have a minimalist approach wherein fewer knobs are present in exchange for an on-screen menu and/or an LCD control screen. Depending on the situation and implementation, different control panels can be customized for different types of applications such as general imaging, obstetrics, vascular, or cardiac, or customized to meet a particular user's preferences or laboratory workflow. Furthermore, control panels can be interchanged between different ultrasound systems based on different platforms. Thus control panels can be shared or reused with multiple types of systems. The modular nature of the control panels in one embodiment also allows the upgrading of the user interface for a system by easily adding, swapping out, substituting, replacing, or removing any control panels. When detached the user interface modules can be set on a table or bed, mounted on a stand, or placed on a rack which may attach to the bed or other object.

The user interface control panel can be composed of a plurality of modules which can be rearranged and detached as needed. For example a modular control panel could consist of a QWERTY keyboard, a trackball with knobs module, and a digital gain control (DGC) module which could be detached and connected to the ultrasound system in different configurations. In some embodiments, the control modules can also contain software to make them “intelligent” and able to perform certain functions.

Although the following embodiments are described with reference to an diagnostic ultrasound system, other embodiments are applicable to other types of medical imaging systems and patient information gathering devices. The same techniques and teachings of the present invention can easily be applied to other types of user controlled systems that can benefit from greater operator flexibility and improved performance. The teachings of the present invention are applicable to any systems or machine that require its operators or users to remain within arm's length of the controls. Moreover, the present invention is not limited to machines in the medical field that involve the presence of an operator during an examination and can be applied to any type of machine in which remote control is desirable.

In addition to better serving the customers' needs, embodiments of the present invention can also provides potential savings to the ultrasound system manufacturer. Because the same control panel elements/keyboard can be used for different ultrasound systems, the cost of developing separate or unique control panel for different ultrasound systems can be reduced or avoided. The cost of service and repair can also be reduced as the components of the control modules can be exchanged to aid in diagnosis of a problem with the ultrasound system and a faulty component can be easily and quickly exchanged for a new component.

In the following description, for purposes of explanation, numerous specific details are set forth in order to provide a thorough understanding of the present invention. One of ordinary skill in the art, however, will appreciate that these specific details are not necessary in order to practice the present invention. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention.

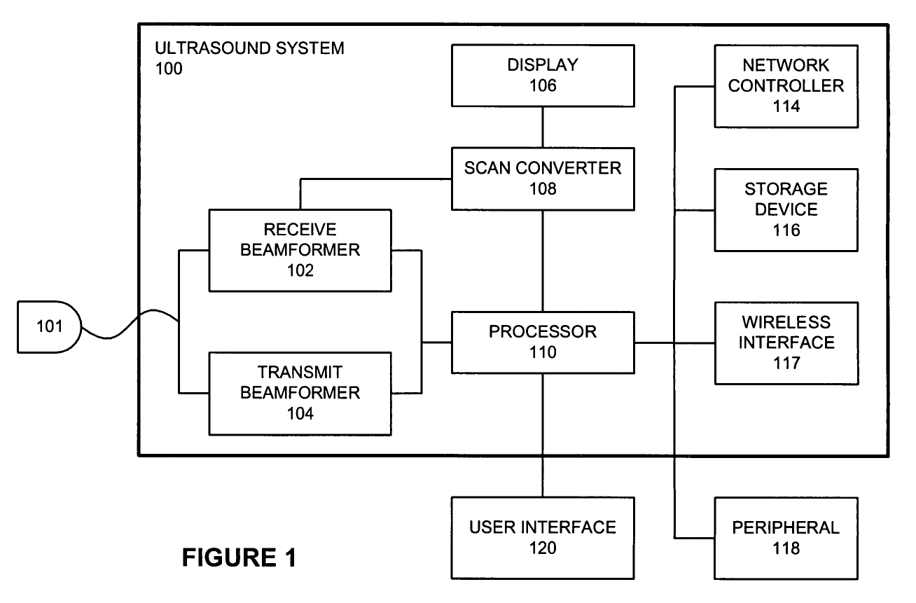

FIG. 1 is a block diagram of a medical diagnostic ultrasound imaging system 100 including detachable and configurable user interfaces 120 in accordance with one embodiment of the present invention. It will be appreciated that the disclosed embodiments are also applicable to other medical diagnostic imaging systems such as computed radiography, magnetic resonance, angioscopy, color flow Doppler, cystoscopy, diaphanography, echocardiography, fluoresosin angiography, laparoscopy, magnetic resonance angiography, positron emission tomography, single-photon emission computed tomography, x-ray angiography, computed tomography, nuclear medicine, biomagnetic imaging, culposcopy, duplex Doppler, digital microscopy, endoscopy, ftndoscopy, laser surface scan, magnetic resonance spectroscopy, radiographic imaging, thermography, radio fluroscopy, or any combination thereof. Further, it will be appreciated that the disclosed embodiments are also applicable to therapeutic ultrasound systems.

As shown in FIG. 1, ultrasound system 100 comprises a transducer 101 coupled with a transmitter, such as a transmit beamformer 104 and a receiver, such as a receive beamformer 102. Alternatively, as described below, other types of transmitters and/or receivers may be used. Herein, the phrase “coupled with” is defined to mean directly connected to or indirectly connected through one or more intermediate components. Such intermediate components may include both hardware and software based components. The beamformers 102, 104, are each coupled with a processor 110, which is coupled with a scan converter 108, user interface 120, network controller 114, storage device 116, wireless interface 117, and a peripheral 118. The processor 110 can also include a memory device that stores software executable by the processor 110. The term “processor” broadly refers to hardware and/or software components of the ultrasound system 100 that can be used to implement the preferred embodiments described herein. It should be understood that any appropriate hardware (analog or digital) or software can be used and that the embodiments described herein can be implemented exclusively with hardware. Further, the processor 110 can be separate from or combined with (in whole or in part) other processors of the ultrasound system 100 (including attendant processors), which are not shown in FIG. 1 for simplicity. It should also be noted that the ultrasound imaging system 100 can comprise additional components. Further, the ultrasound system 100 can be used with any suitable imaging mode (e.g., B-mode imaging, Doppler imaging, tissue harmonic imaging, contrast agent harmonic imaging, etc.), and the transducer 101 can be of any type (e.g., ID, 1.5D, 2D, plano-concave, single element, phased-array, etc.).

In operation, the processor 110 responds to information and commands entered through the user interface 120 and controls the operation of the ultrasound system 100. User interface 120 can include a keyboard, trackball, pointer device, sliding controls, etc. In one embodiment, the user interface 120 also includes hardware to receive and process biometric data. The processor 110 causes the transmit beamformer 104 to apply a voltage to the transducer 101. The transducer 101 vibrates and emits an ultrasonic beam into an object, such as human tissue (i.e., a patient's body). Ultrasonic energy reflected from the body impinges on the transducer 101, and the resulting voltages created by the transducer 101 are received by the receive beamformer 102. The scan converter 108, under control of the processor 110, processes the sensed voltages to create an ultrasound image associated with the reflected signals and displays the image on a display 106. The user interface 120 can be used, for example, to adjust parameters used in the transmit, receive, and display operations. It should be noted that the ultrasound imaging system 100 can comprise additional components. Embodiments of the present invention include user interfaces 120 that are comprised of one or more detachable user control modules that can wirelessly operate in conjunction with the system 100. The processor 110 can also store the generated image and other ultrasound examination data in the storage device 116 (e.g., a hard drive). As used herein, the term “ultrasound examination data” is meant to broadly refer to ultrasound image data (still images and/or dynamic clips) and/or non-image data (such as calculation data and patient data) associated with an ultrasound examination. Thus ultrasound data can include, but is not limited to, ultrasound examination data, images, audio data, calculations, reports, screen captures of measurements or report data, indications of diagnosis, raw system data (such as prescan-converted acoustic data, physio waveforms, operating parameters, and front-end complex data of coherent beam forming systems), information about the ultrasound system, information about an ultrasound peripheral, and software applications that can be installed by the ultrasound system's processor.

It will be appreciated that alternative methods of generating and controlling ultrasonic energy as well as receiving and interpreting echoes received therefrom for the purpose of diagnostic imaging, now or later developed, may also be used with the disclosed embodiments in addition to or in substitution of current beamforming technologies. Such technologies include technologies which use transmitters and/or receivers which eliminate the need to transmit ultrasonic energy into the subject along focused beam lines, thereby eliminating the need for a transmit beamformer, and may permit beam forming to be performed by post processing the received echoes. Such post-processing may be performed by a receive beamformer or by digital or analog signal processing techniques performed on the received echo data.

Also for simplicity, the term “ultrasound peripheral” is used here to broadly refer to any device that can receive ultrasound data from the ultrasound system 100 and/or that can transmit ultrasound data to the ultrasound system 100. The widest variety of devices can be used as ultrasound peripherals, such as, but not limited to, video imagers, digital workstations, analog or digital mass storage devices, analog or digital video recording devices, printers, as well as other ultrasound imaging systems. In some situations, a device, such as a printer, can be used in the network to receive both ultrasound data (hence, acting as an ultrasound peripheral) and non-ultrasound data from other devices or applications.

A network controller 114 coupled to the processor 110 enables the ultrasound system 100 to communicate with devices and systems through a network. To transmit ultrasound data to an ultrasound peripheral that is not located proximate to the ultrasound system 100, the processor 110 provides a network controller 114 with an instruction to transmit ultrasound data as well as with the location of the ultrasound data to be transmitted. The network controller 114 retrieves the ultrasound data from the location and then packages and addresses the data according to a network protocol such as IEEE 802, TCP/IP, or UDP, for example. To transmit ultrasound data to an on-cart peripheral 118 connected to the ultrasound system 100 with a wired connection, the processor provides the ultrasound data directly to the on-cart peripheral 118, such as a VCR.

In one embodiment, the medical diagnostic ultrasound imaging system 100 comprises a housing that has an integrated wireless interface 117. For simplicity, the term “wireless” is used here to broadly refer to any technology that allows the transfer of data from one point to another without the use of a physical connection, for instance via the electromagnetic spectrum. Further, data can be wirelessly transmitted in analog or digital form. The wireless interface 117 allows the ultrasound system 100 to communicate with wireless devices such as wireless user interface modules and wireless peripherals. For simplicity, the terms “wireless interface” and “wireless communication device” are used here to broadly refer to any device that has the ability to transmit and receive analog or digital information from one point to another without the use of a physical connection.

A wireless interface can be integral with the system 100, user interface 120, or peripheral 118. The wireless interface can also comprise an add-on component to the system 100 such as where the wireless communication device 117 is a detachable accessory that is tethered to the system 100. A wireless communication device can include an emitter, receiver, and/or transceiver. In some embodiments, a wireless communication device is capable of communicating virtually simultaneously in receive and transmit modes (e.g., by time-slicing between operations) and/or capable of communicating virtually simultaneously with more than one wireless device (e.g., by time-slicing between the wireless devices). Examples of wireless communication devices include, but are not limited to, devices that communicate information using infrared, radio frequency, light wave, microwave, or ultrasonic transmissions. Embodiments of the present invention are not restricted to any particular type of wireless link or wireless components, and can be practiced through the use of any suitable wireless communication methods.

For one embodiment of the present invention, the system 100 can include a user interface processor coupled to the processor 100 and wireless interface 117 for processing commands upon arrival from either the wireless interface 117 or from a wired source. A user interface processor can be comprised of general processor, a digital signal processor, an application specific integrated circuit, analog device, digital device and/or combinations thereof. The user interface processor can be physically implemented as an integral part of the user interface. In one embodiment, software on the user interface processor can provide tools for copying or otherwise indicating imaging parameters or objects for use on a custom menu or a custom page in response to a user selection. For example, a user can select one or more imaging parameters from different preprogrammed menus for providing the selected imaging parameters on a single custom page or as part of a custom menu setup. It should be noted that an ultrasound system operation can be any operation or function that is performable by the ultrasound system and can include the selection and/or operation of system peripherals 118. The term “ultrasound system command” is used herein to refer to any command that, upon receipt by the ultrasound system, causes the ultrasound system to perform an operation.

The wireless interface 117 of one embodiment allows for bidirectional control between the ultrasound system 100 and wireless devices such as detached user interface modules 120. The user interface control modules 120 of the ultrasound system 100 also have wireless communication interfaces to conduct wireless communications. The detachable user interface modules 120 are capable of receiving user commands and in turn communicating those commands to the system 100. When the ultrasound system 100 receives a command, an ultrasound system operation associated with the command is performed. Thus the detachable user interface modules are remote wireless input devices that allow a user to input information to the system 100 for debugging or scanning a patient. In one embodiment, the processor translates the ultrasound system command into an ultrasound system operation. Similarly, the detachable user interface components 120 of one embodiment are capable of performing an operation in response to receipt of commands or data from the system 100 via built-in wireless capabilities. Thus data can be sent wirelessly from the system 100 to displays on the user interface 120 and commands can be received wirelessly at the system 100 from the detached control interface. The wireless interface 117 can involve one or more of the following types of technologies: infrared, radio frequency (RF) based such as Bluetooth or 802.11(b), serial, cellular, or combinations thereof including wireless interface technologies now or later developed such as satellite based technologies.

The wireless interface 117 is positioned in the housing to allow wireless communication between the wireless communication device and a wireless interface of a peripheral or user control module in proximity with the system 100. For example, when the wireless interface 117 communicates with infrared transmissions, it is preferred that the wireless communication device be positioned in the housing to provide an unimpeded optical path between the wireless communications device of the housing and the wireless communication device of a detached user interface control module.

In one embodiment, the system and detachable user interface are compatible with the IrDA infrared communication protocol developed by the Infrared Data Association. IrDA devices provide a walk-up, point-to-point method of data transfer that is adaptable to a broad range of computing and communication devices. For one embodiment, an infrared transmitter is integrally mounted to the housing and the infrared transmitter is coupled with processor 110. An infrared lens is mounted over the transmitter to aim infrared transmission to an infrared receiver of devices such as a detached control panel or a peripheral.

For one embodiment, commands as entered into a detached user interface are wirelessly transmitted from a first wireless communication device at a detached control module to a second wireless communication device at the system. The first wireless communication device of one embodiment encodes the commands to modulate a wireless transmitter. For one embodiment, the communications are encoded such that one specific ultrasound system can be controlled through the commands. This encoding can prevent a control module from inadvertently controlling a wrong ultrasound system located proximately within wireless range. Several modulation and encoding techniques can be used, such as amplitude modulation, frequency modulation, or phase modulation. Variants or combination of these techniques can also be used. The second wireless communication device at the system receives the commands wirelessly transmitted by the first wireless communication device. After the wireless communication device at the system detects, demodulates, and decodes the commands, the processor executes the commands and the system responds accordingly.

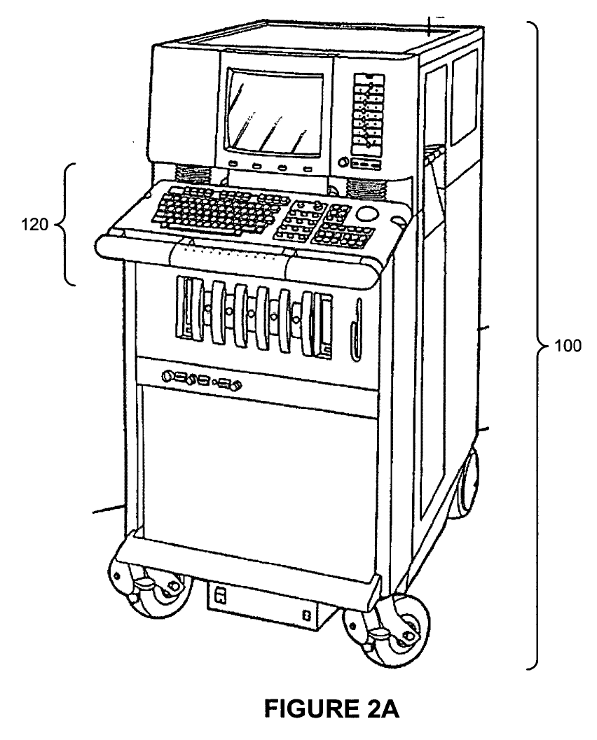

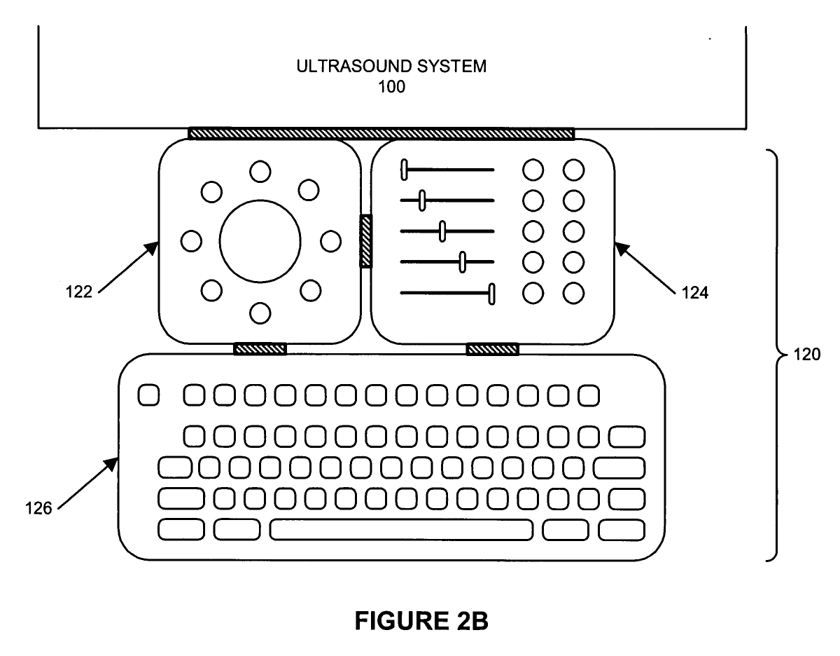

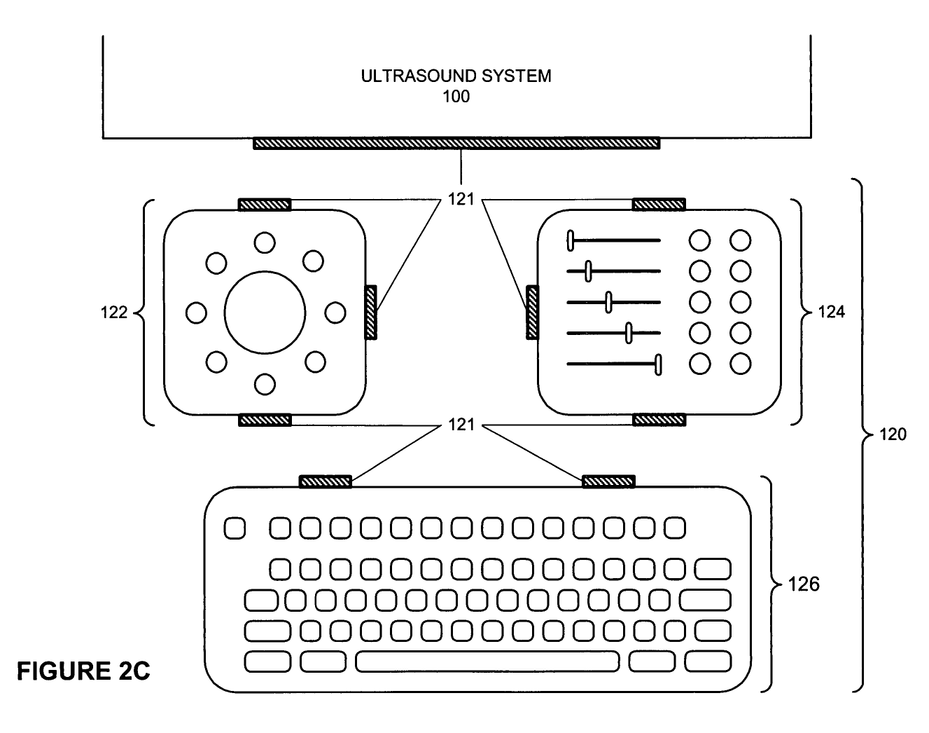

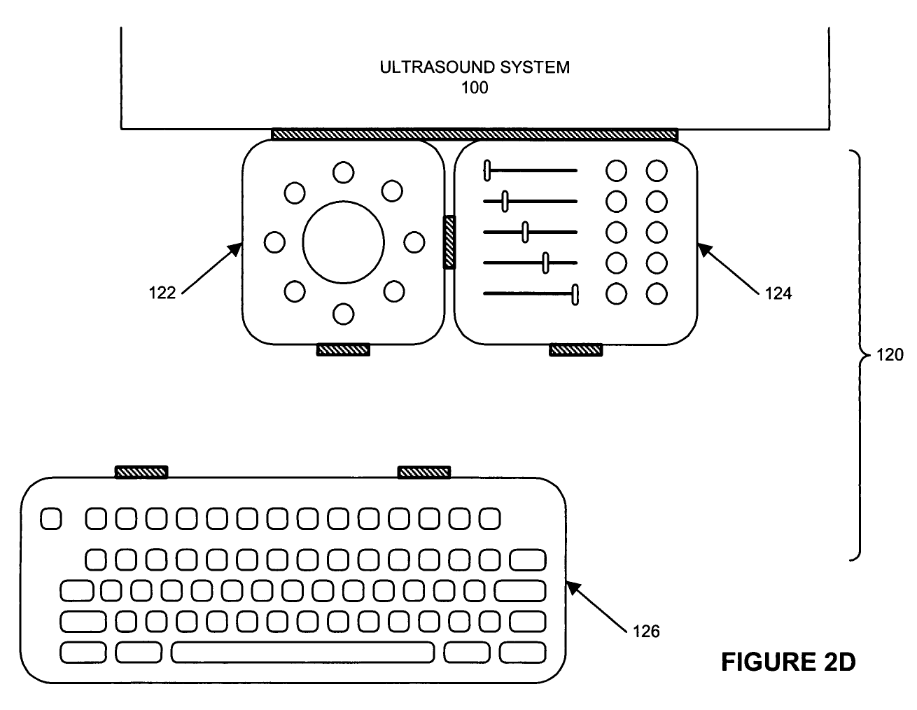

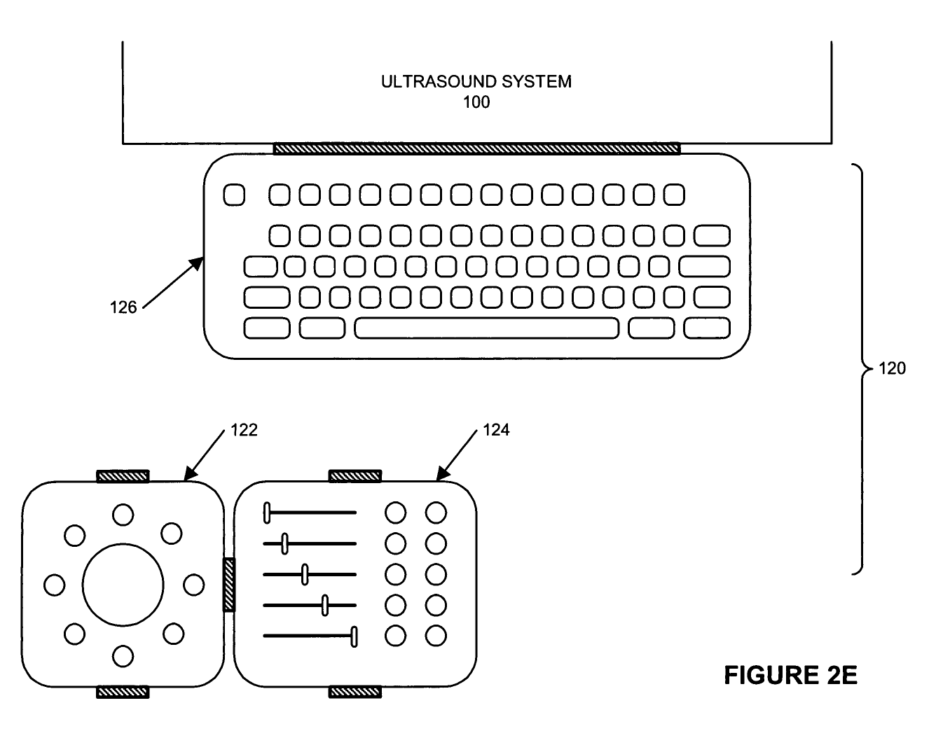

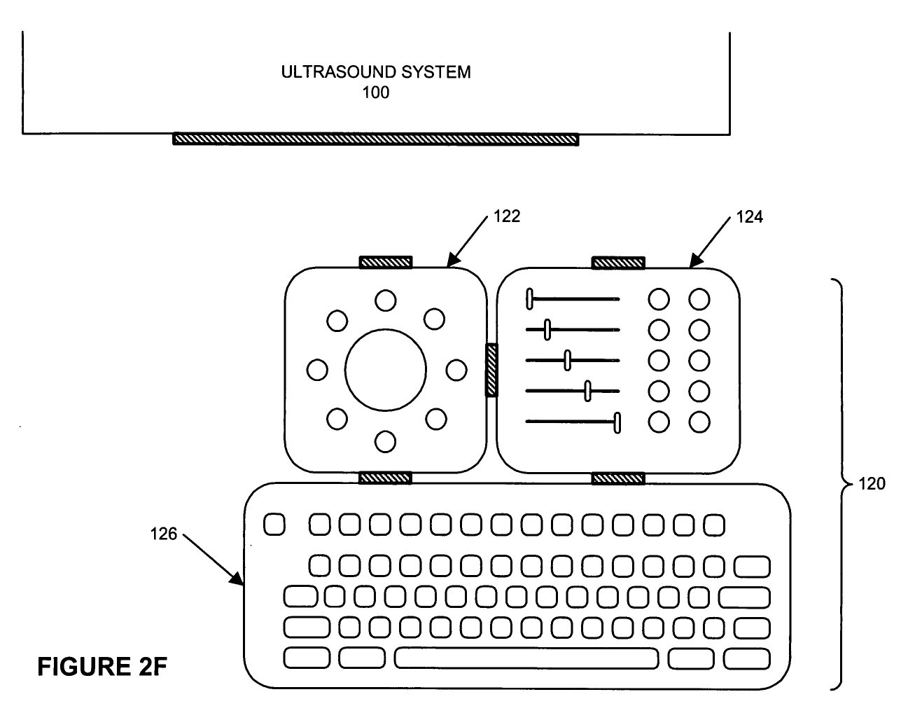

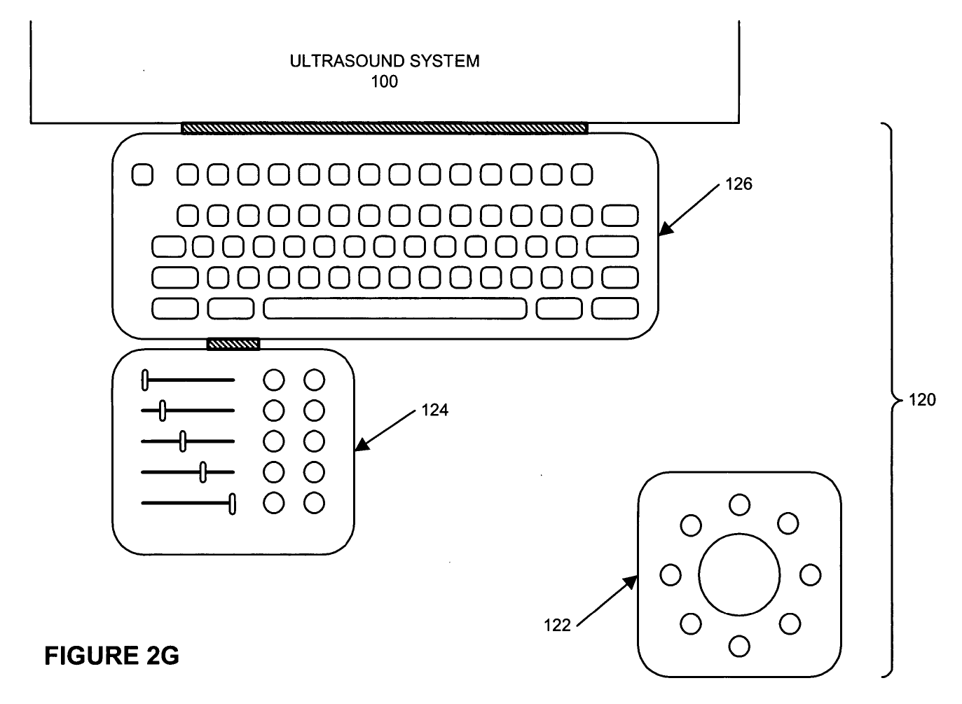

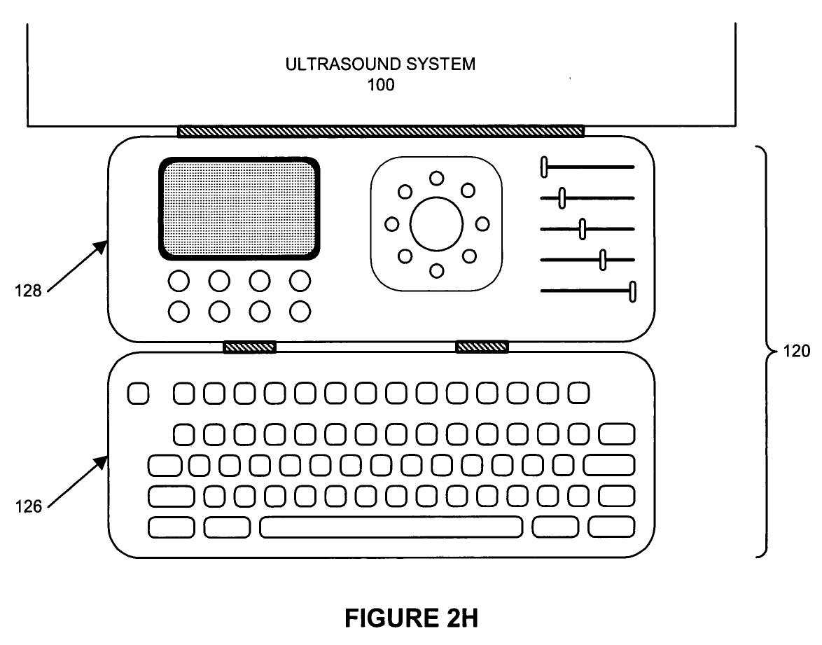

Currently available ultrasound systems typically include a user interface that is generally physically attached to the system console and is neither configurable nor detachable. In fact, these types of user interfaces are permanently mounted to the console and do not permit an operator to effectively operate or use the user interface unless the operator is seated directly in front of or adjacent to the system 100. FIG. 2A illustrates an ultrasound system 100 having a user interface 120 comprising a keyboard, knobs, buttons, and a trackball. As illustrated in FIG. 2A, the detachable user interface 120 for embodiments of the present invention can be directly attached or mounted onto the system 100. The detachable user interface 120 is capable of exchanging data with and controlling the ultrasound system 100. But unlike current system designs wherein the user interface is fixed, embodiments of systems in accordance to the present invention provide for detachable and configurable user interfaces. Furthermore, the use of a data transmission medium to physically couple and communicate data between the ultrasound system 100 and the detachable user interface 120 is optional as embodiments of systems and user interfaces based on the present invention are capable of wireless communications. The user interface 120 of some embodiments of the present invention can be comprised of one or more input devices, such as on or more of a keyboard, dedicated hard keys, software programmable keys, touch screen, touch sensors, knobs, switches, sliders, joystick, trackball, scroll wheel, mouse, push buttons, radio buttons, soft buttons (software controlled buttons), position sensing devices, rocker switches, toggles, combinations thereof or any now known or later developed user input devices.

An operator of a diagnostic ultrasound imaging system 100 is capable of accessing and modifying countless system menus, configuration pages, settings, and imaging functions through the use of the user interface 120 when using the machine. Thus extensive control of the ultrasound system is allowed by embodiments of the present invention. Any given page or menu structure can include one, two or more, such as hundreds of objects or imaging parameters. For example, a preprogrammed page provides real time control imaging parameters, such as vector tables and scan sequencing information. As another example, a preprogrammed page includes imaging parameters associated with frame rate for controlling higher level sequencing, such as triggering, calculation and other timing information. As yet another example, a contrast state preprogram page is provided with imaging parameters associated with contrast agent imaging. Pages associated with B-mode scanning, Doppler scanning, three-dimensional imaging, two-dimensional imaging, transducer type, waveform generation or other imaging functions or applications are possible. Other menu structures with different groupings of imaging parameters and parameter objects may be provided.

As used herein, imaging parameter includes any of various variables or tables of variables for controlling the acquisition, data storage and image processing of medical image information. Imaging options include imaging parameters available to a user for setting or enabling. For ultrasound applications, imaging parameters include beam forming variables, filter variables, B-mode detection variables, Doppler detection variables, spectral Doppler detection variables, scan converting variables, post-processing parameters, signal processing, data storage, system configuration and any other now known or later developed variables associated with generating an ultrasound image. For example, imaging parameters include the user controlling the storage of data from one of multiple locations along the processing path for later generation of an image, configuring the system to collect data on an element-by-element basis or running a specific script for imaging. Beamforming parameters include scan line spacing, angle, origin, signal frequency, pulse repetition frequency, sampling rate, or other now known or later developed beamforming variables. Filtering parameters include weights, number of taps, infinite impulse response characteristic, finite impulse response characteristic, pass band, or other now known or later developed filtering characteristic. Objects include imaging parameters as well as non-imaging parameters, such as values calculated from imaging information, information for interfacing with other systems, such as VCRs, memories, network transmission, display objects for annotation, display format, and graphics, or other now known or later developed variables used by the system 100. A page includes a window, box, section of a screen, an entire screen or other collection of display information. In an alternative embodiment, a menu, outline, icons, tool bar or other organization of objects is provided. Thus the user interface 120 is a critical part of the system 100.

FIGS. 2B-H are illustrations of various user interface configurations for detachable control modules as implemented on an ultrasound system in accordance with one embodiment of the present invention. Embodiments of this invention allow for the user customization of the user interface 120. This different control panel layouts can be used on the same ultrasound system 100. Similarly, multiple control modules accommodating different applications or user preferences are possible. For these exemplary configurations, the detachable user interface 120 is comprised of a trackball module 122, a digital gain control module 124, and a keyboard module 126. However, it is contemplated that various other control modules or input units are possible and the scope of the present invention is not limited as such. In one embodiment, these control modules can serve as the primary control of the ultrasound system when attached to the ultrasound system. In another embodiment, these control modules can operate independent of the primary controls on the system. FIG. 2B illustrates a first user interface configuration. As illustrated in the configuration of FIG. 2B, the control modules 122, 124, 126, are all physically coupled together and mounted to the ultrasound system 100. For example, the trackball module 122 and gain control module 124 are both coupled to the system 100 via mating points. The trackball module 122 and gain control module 124 are also coupled to each other at mating points. The keyboard 126 in turn is coupled to the trackball module 122 and the gain control module 124 at two mating points. The modules of one embodiment connect together so that they can be removed either singly or together as a single unit. In one embodiment, the mating points include mechanical and electrical interfaces. For example, a mechanical interface can provide a physical latching mechanism to capture and/or support a user interface module during mating. Similarly, an electrical interface can provide a physical connection to a mated user interface module to provide power and/or a physical communication link. Thus a module that is a physically coupled, either directly or indirectly, can be operating off the system power and/or recharging its internal power supply. In alternate embodiments, the system 100 can include a cradle or other points of connectivity to receive the user interface modules.

FIG. 2C illustrates a second user interface configuration wherein the user interface modules 120 are all detached from the system 100 and from each other. In this configuration, the trackball module 122, gain control module 124, and keyboard module 126 can be used separate and independent from the others. Thus the ultrasound system operator can freely move about the system 100, patient, and/or the examination room. Similarly, because the user interface modules 120 can be operated independently, multiple users can be controlling the system 100. For example, a sonographer can be typing notes on the keyboard 126 or adjusting the image on the gain control module 124, while a doctor is scrolling about the image with the trackball 122. Also visible in FIG. 2C are the mating points 121 through which system 100 and the detachable user interface modules can be mated or docked together. As used herein, the terms “mated” and “docked” are defined to mean that the one or more modules and/or the system are physically coupled together via a physical interface wherein a logical link such as data interchange or an electrical link such as power transfer is possible between these devices. When the control modules are docked with the ultrasound system the modules remains fully functional. While docked its batteries are charged either by direct connection to the power source or through magnetic induction. In this example, the user interface modules can be physically coupled together or to the system at available mating points 121. For some implementations, mechanical and/or electrical links are formed when two mating points 121 are brought together. In other embodiments, a physical communication link is also created at the mating points 121 when connected together. Although the system 100 and user interface modules 120 are shown with a particular number of mating points 121 in FIG. 2C, the number and location of mating points 121 can vary depending on the specific implementation.

For this embodiment, when a user interface module is detached from the system 100, that module is powered by a battery source located within the module and each detachable user interface module includes a battery or power source. In one embodiment, the battery is a rechargeable battery that is recharged when the module is physically docked or mated with the system 100. In another embodiment, the battery is a long life lithium battery. In other implementations, various other types of power supplies and batteries can be employed. Furthermore, when a user interface modules is detached from the system 100, that module communicates with the system 100 through a wireless communication link. For this embodiment, each detachable user interface module includes a wireless communication device that can communicate and interface with the system 100. In some embodiments, a detachable user interface module can also communicate wirelessly to another user interface module and/or a system peripheral 118 either directly or via the wireless interface 117 of system 100. If each control module includes its own power source and wireless communication device, it can operate independently when detached. In one low cost embodiment, only one of the modules contains a battery and wireless communication device; in which case the other detached control modules must be attached this module in order to function.

FIG. 2D illustrates a third user interface configuration wherein the keyboard 126 is detached from system 100 and the other modules 122, 124. In this configuration, the trackball module 122 and gain control module 124 are still mated with the system 100. The keyboard 126, on the other hand, can be used away from the system 100 via wireless link. FIG. 2E illustrates a fourth user interface configuration wherein the keyboard 126 is mated with system 100 and the other modules 122, 124 are detached. In this fourth configuration, the trackball module 122 and gain control module 124 are still mated with each other, but detached from the system 100 itself. Thus the keyboard 126, can be used at the system 100, which the trackball 122 and gain control 124 can be used away from the system 100 via wireless link.

FIG. 2F illustrates a fifth user interface configuration wherein the entire user interface 120 is detached from system 100. In this configuration, however, the trackball module 122, gain control module 124, and keyboard 126 are all mated together as a single control panel. Thus the user can wirelessly control the system 100 without being within arms reach of the system 100. FIG. 2G illustrates yet another configuration wherein the trackball module 122 is detached from system 100. In this configuration, the keyboard 126 is directly mated to the system 100 and the gain control module 124 is coupled to the system 100 via the keyboard 126. Thus control modules can be arranged such that specific modules are closer within reach or detached from the system 100. The number of different possible configurations for combining various user interface modules can be large. With embodiments of the present invention, a user has the opportunity to create an optimal detached user interface configuration.

FIG. 2H illustrates another interface configuration wherein the user interface 120 can utilize other types of control modules. The user interface modules as described in these examples are by no means limiting and alternate embodiments in accordance with the present inventions are not restricted as such. In fact, other types of control modules having a variety of features and functionality are possible. Furthermore, some of the modules can also contain software that provide added functionality. In this alternative configuration, the individual trackball module 122 and gain control module 124 have been replaced with an integrated control panel 128. The wireless integrated control panel 128 of this example includes not only a trackball and gain control knobs, but also a display screen. The display screen of one embodiment is operable to display various menus, a custom page, a custom menu and/or preprogrammed menus as part of the user interface 120. The display screen can also be a monitor, CRT, LCD, plasma screen, viewfinder, flat panel, projection or other display device now known or later developed for displaying a medical image, such as an ultrasound B-mode or color Doppler image. The integrated control panel 128 is mated to the system 100 and the keyboard 126 is mounted to the panel 128. As with the modules described in the configurations above in FIGS. 2B-G, the integrated control panel 128 of this embodiment can also be detached from the system 100 and configured in different arrangements with other modules. Thus embodiments of the present invention allow for modularity of the detachable controls wherein the user can detach only those parts of the user interface that need to be used remotely.

Similarly, the detachable control panels allow for easy user interface upgrades if new control modules become available or if other control modules having different features and functionality are needed for use with the system. For example, a low cost gain control module having limited controls can be easily upgraded with an advance control module such as an “intelligent” control module that includes software for tissue gain optimization. Furthermore, the detachable control panels of one embodiment can be shared with multiple systems, whether the systems are identical or different. For example, a detachable control module of a mid-range system can also be used as part of the user interface of a high-range system. Although the detachable control modules as described in these example embodiments each include individual power supplies and are capable of wireless communication, it is contemplated that the control modules of some embodiments can be without its own power supply and/or without wireless communication capability. For example, a control module without wireless capability from the user interface of one system can similarly be shared or exchanged with another system of a different platform or platform type.

In one embodiment, certain individual control modules are loaded with software to make these modules “intelligent modules” that can, for example, provide recognition codes to allow operation of only one ultrasound system at a time and prevent operation of the system by other modules, provide estimates of battery life, or provide user identification and permissions. Software in the individual control modules can also provide more complex functions such as word completion during annotations. Features such as an automated digital gain control (tissue equalization technology) can be associated with software in one of the detachable modules. Having a feature reside within a user interface module rather than on the main ultrasound system can provide for additional user flexibility.

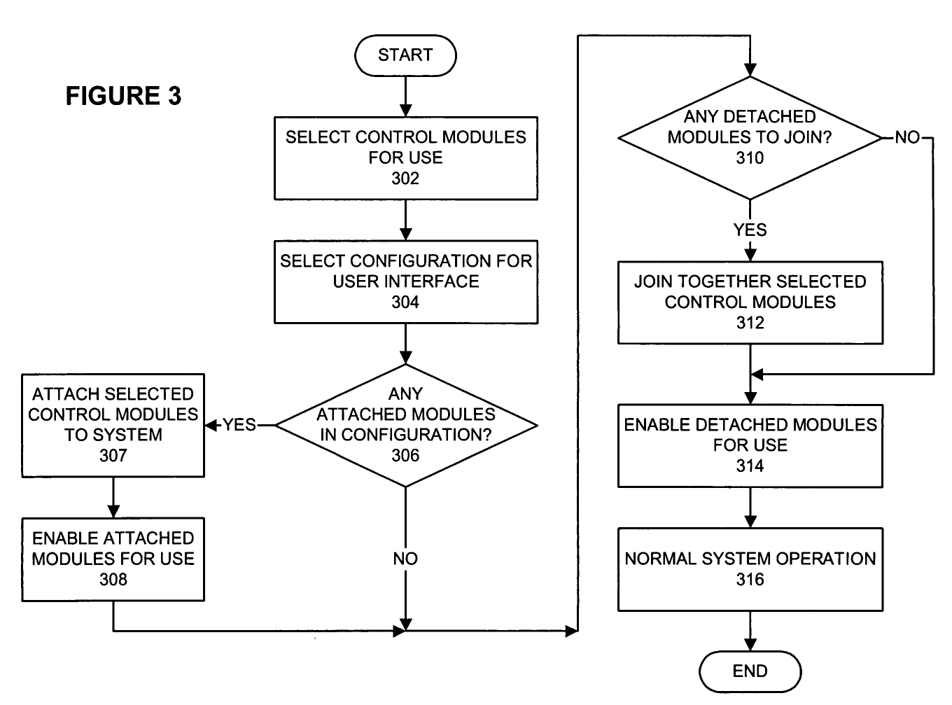

FIG. 3 is a flowchart illustrating one embodiment of a method to configure detachable user control panels for use with a diagnostic ultrasound imaging system. At block 302, a user selects which control modules to use for the user interface to the system. A configuration in which to arrange the control modules is selected at block 304. For example, a user has to determine whether the user interface configuration should have detached control modules, how many, and which ones. A check is performed at block 306 to determine whether the selected user interface configuration includes any control modules to be physically attached (mated or docked) to the system. If the determination at block 306 indicates that some control modules need to be attached, these control modules are attached to the system at block 307. The attached modules are enabled for use at block 308. In one embodiment, the enablement operation can comprise turning on the attached modules and initializing a communication link (whether wireless or via physical link) with the system. The flow continues to block 310 to determine whether any detached control modules need to be joined or mated together.

If the determination at block 306 indicates that no control modules are to be attached a check is performed at block 310 to determine whether any of the selected control modules are to be joined or mated together. If the determination at block 310 indicates that one or more detached modules are to be joined together, these modules are mated together at block 312. If the determination at block 310 indicates that none of the detached modules are to be mated together, the operation at block 312 is skipped. At block 314, the detached control modules are enabled for use. In one embodiment, this act of enabling comprises powering on and/or resetting the control module to a known state. Furthermore, the wireless interface on the control module may need to be initialized and configured to operate with the wireless interface of the system. For example, a logical link may need to be established wherein data exchange is possible between a control module and the system. The initialization can include ensuring that necessary protocol negotiations have been completed and that the system recognizes the detached control modules. For one embodiment, the system can automatically recognize and initiate/establish a wireless link with any control module that is brought within a particular proximity of the system housing. If more than one control module attempts to communicate with the system, the wireless interface on the system is capable of resolving conflicts between the modules. In one instance, such conflicts can be resolved by temporarily locking out one or more of the control modules from being able to control the ultrasound system or by mediating the access among the control modules such through a round robin priority scheme. At block 316, normal system operation occurs and the system operator can perform the desired patient examination by using the control modules, including both those are physically attached to the system and those that are detached.

Although the embodiments as described in the present examples are in the context of diagnostic medical ultrasound systems and medical data systems, other embodiments of the present invention are also applicable in non-medical related fields as well. For example, where the convenience and flexibility of operating a system wirelessly away without having to sit directly in front of the system the whole duration of an examination or discussion. For example, alternative embodiments of the present invention can be utilized in governmental agencies, educational institutions, and other environments where it is desirable to have the flexibility to operate a system through wireless controls. Similarly, the present enhancements are not limited to medical systems or computer workstations. Alternative embodiments of the present invention can be used in other devices such as manufacturing equipment and embedded systems.

Thus, techniques for a method and apparatus for detachable and configurable user interfaces for ultrasound systems are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising
a mating surface to physically receive a detachable user interface, wherein said detachable user interface is comprised of a plurality of wireless control modules; and
a wireless communication device coupled to a processor, said wireless communication device to receive commands from said detachable user interface, said wireless communication device further to communicate said commands to processor for execution.

2. The apparatus of claim of claim 1 wherein said detachable user interface is user configurable, wherein said plurality of wireless control modules can be arranged into a plurality of configurations.

3. The apparatus of claim 2 wherein a first user interface configuration is comprised of at least two wireless control modules that are physically detached from said mating surface and from any other wireless control modules.

4. The apparatus of claim 2 wherein a first user interface configuration is comprised of at least two wireless control modules that are mated together and physically detached from said mating surface.

5. The apparatus of claim 1 wherein one of said plurality of wireless control modules is a trackball module.

6. The apparatus of claim 1 wherein one of said plurality of wireless control modules is a gain control module.

7. The apparatus of claim 1 wherein one of said plurality of wireless control modules is a keyboard module.

8. The apparatus of claim 1 wherein said processor is coupled to said mating surface to receive commands from said detachable user interface via a physical link when said detachable user interface is mated to said mating surface.

9. The apparatus of claim 1 wherein a physical communication link is formed between said processor and a wireless control module when said wireless control module is mated to said mating surface.

10. The apparatus of claim 1 wherein an electrical link is formed between a power supply and a wireless control module when said wireless control module is mated to said mating surface, wherein a battery within said wireless control module is recharged.

11. The apparatus of claim 1 wherein said wireless communication device is to communicate data from said processor to one of said plurality of wireless control modules.

12. A medical diagnostic ultrasound imaging system comprising:
a transducer coupled with a transmit beamformer and a receive beamformer;
a processor coupled to issue commands to said transmit beamformer and to receive data from said receive beamformer;
a wireless communication device coupled to said processor, said wireless communication device to receive a command from a detachable user interface and to communicate said command to said processor; and
wherein said detachable user interface is dynamically configurable and comprised of at least one wireless control module to receive user input and to wirelessly transmit said user input to said wireless communication device as said command.

13. The system of claim 12 wherein said system further comprises a mating interface to physically connect with a wireless control module.

14. The system of claim 13 wherein a physical communication link is formed between said system and said wireless control module when said wireless control module is physically connected with said mating surface.

15. The system of claim 13 wherein an electrical link is formed between said system and said wireless control module when said wireless control module is physically connected with said mating surface, said electrical link to recharge a battery of said wireless control module.

16. The system of claim 12 wherein said detachable user interface is comprised two control modules for arrangement in a variety of configurations.

17. The system of claim 12 wherein a first user interface configuration is comprised of at least two wireless control modules that are physically detached from said system and from any other wireless control modules.

18. The system of claim 17 wherein a first user interface configuration is comprised of at least two wireless control modules that are mated together and physically detached from said system.

19. The system of claim 12 wherein said at least one wireless control module is a trackball module.

20. The system of claim 12 wherein said at least one wireless control module is a digital gain control module.

21. The system of claim 12 wherein said at least one wireless control module is a keyboard module.

22. The system of claim 12 wherein said detachable user interface is physically detached from said system and located within wireless communication range during normal operation.

23. An apparatus comprising:
a first detachable control module having wireless communication capability, a first internal power source, and a first mating surface;
a second detachable control module having wireless communication capability, a second internal power source, and a second mating surface; and
wherein said first and second detachable control modules are configured to operate as portions of an user interface to an medical imaging system, said user interface detachable from said medical imaging system.

24. The apparatus of claim 23 wherein said first and second detachable control modules each wirelessly communicate user input to said medical imaging system.

25. The apparatus of claim 23 wherein said first detachable control module and said second detachable control module are mated together at said first and second mating surfaces to form an integrated user interface unit.

26. The apparatus of claim 23 wherein during normal operation, said first detachable control module is physically coupled to a mating surface of said medical imaging system and said second detachable control module is physically detached from said medical imaging system.

27. The apparatus of claim 23 wherein said medical imaging system is a diagnostic ultrasound imaging system.

28. The apparatus of claim 23 wherein said first detachable control module is a trackball module.

29. The apparatus of claim 23 wherein said first detachable control module is a digital gain control module.

30. The apparatus of claim 23 wherein said first detachable control module is a keyboard module.

31. A method comprising:
determining a user interface configuration for a system, wherein said user interface configuration includes a user interface that is physically detached from said system during system operation;
detaching a plurality of detachable control modules from said system;
arranging said plurality of detachable control modules into said user interface configuration;
enabling said plurality of detachable control modules to wirelessly communication commands to said system.

32. The method of claim 31 wherein said determining further comprises:
selecting said plurality of detachable control modules for use, each of said detachable control modules having wireless communication capability and a mating surface to mate with another mating surface;

33. The method of claim 31 wherein said system further comprises a mating surface to receive a detachable control module.

34. The method of claim 31 wherein said user interface configuration is determined based on which feature set are needed from said plurality of detachable control modules.

35. The method of claim 31 wherein each of said control modules can mate with another control module or said system.

36. The method of claim 35 wherein said plurality of control modules are physically mated together to form said user interface.

37. The method of claim 31 wherein each of said detachable control modules operate independently from each other, wherein said user interface is comprised of a set of physically separate control modules.

38. The method of claim 31 wherein said system further comprises a detachable control module that is mated to said system during said normal operation.

39. The apparatus of claim 1 wherein one of said plurality of wireless control modules is interchangeable with control modules of different system.

40. The apparatus of claim 1 wherein one of said plurality of wireless control modules is an intelligent control module.

41. The apparatus of claim 40 wherein said intelligent control module includes software to perform tissue gain control.

42. The apparatus of claim 1 wherein one of said plurality of wireless control modules is upgradeable.

43. The apparatus of claim 42 wherein additional functionality is available upon upgrading said one of said plurality of wireless control modules.

44. The apparatus of claim 1 wherein said detachable user interface is further comprised of a control module without wireless communication capability.

45. The apparatus of claim 44 wherein said control module without wireless communication capability is shared with a different platform.

46. The system of claim 12 wherein said at least one wireless control module is interchangeable with control modules of a different system.

47. The system of claim 12 wherein said at least one wireless control module is an intelligent control module and includes software to perform tissue gain control.

48. The system of claim 12 wherein said at least one wireless control module is upgradeable and additional functionality is available upon upgrading.

49. The system of claim 12 wherein said detachable user interface is further comprised of a control module without wireless communication capability.

50. The system of claim 49 wherein said control module without wireless communication capability is shared with a different platform.

51. The apparatus of claim 23 further comprising a third detachable control module having a third mating surface and without a wireless communication capability, said third detachable control module configured to operate as a portion of said user interface to said medical imaging system.
